(19) United States
(12) Patent Application Publication
(10) Pub. No.: US 2013/0315598 A1
(43) Pub. Date: Nov. 28, 2013

(54) SYSTEM AND METHOD FOR USE IN WAVELENGTH DIVISION MULTIPLEXER

(71) Applicant: Yissum Research Development Company of the Hebrew University of Jerusalem Ltd., (US)

(72) Inventors: Dan Mark MAROM, Mevaseret Zion (IL); David SINEFELD, Jerusalem (IL)

(21) Appl. No.: 13/870,339

(22) Filed: Apr. 25, 2013

Related U.S. Application Data
(60) Provisional application No. 61/638,232, filed on Apr. 25, 2012.

(51) Int. Cl. H04J 14/02

(52) U.S. Cl. CPC H04J 14/0224
USPC 398/79

(57) ABSTRACT

A system and method are presented for use in dense wavelength division multiplexing. According to this technique, K spatially separated broadband optical beams are produced comprising respective K arrays of spectral components arranged with certain common periodicity, P, where the spectral components present data channels and are arranged in interleaved fashion in the K arrays, with spectral components of one array being shifted with respect to the next array a value substantially equal to said periodicity divided by number of separated broadband beams, or P(K−1)/K. Spectral shaping is applied to the K arrays to convert modulated-shape of the spectral components in the K arrays to K groups of desired spectral shape of data channels. This enables to combine the K groups of the spectral channels into a combined beam comprising all the spectral channels being arranged with substantially no gap between the channels.

### TECHNOLOGICAL FIELD

The present invention is generally in the field of optical communication, and relates to a method and system for use in wavelength division multiplexer (WDM) and in particular Nyquist Wavelength Division Multiplexing (N-WDM).

### REFERENCES

The following are references considered to be relevant to background of the present invention:
1. G. Bosco, A. Carena, V. Curri, P. Poggiolini, and F. Forghieri, “Performance Limits of Nyquist-WDM and CO-OFDM in High-Speed PMQPSK Systems,” IEEE Photon. Technol. Lett. 22 (15), 1129-1131 (2010).
2. G. Bosco, V. Curri, A. Carena, P. Poggiolini, and F. Forghieri, “On the performance of Nyquist-WDM terabit superchannels based on PMBPSK, PM-QPSK, PM-8QAM or PM-16QAM subcarriers,” J. Lightwave Technol. 29,53-61 (2011).
3. R. Cigliutti, E. Torrengo, G. Bosco, N. P. Caponio, A. Carena, V. Curri, P. Poggiolini, Y. Yamamoto, T. Sasaki, and F. Forghieri, “Transmission of 9×138 Gb/s prefiltered PM-8QAM signals over 4000 km of pure silica-core fiber,” J. Lightwave Technol. 29,2310-2318 (2011).
4. Z. Dong, J. Yu, H. Chien, N. Chi, L. Chen, and G. Chang, “Ultra-dense WDM-PON delivering carrier-centralized Nyquist-WDM uplink with digital coherent detection,” Opt. Express 19, 11100-11105 (2011).
5. M. Nakazawa, T. Hirooka, P. Ruan, and P. Guan, “Ultrahigh-speed “orthogonal” TDM transmission with an optical Nyquist pulse train,” Opt. Express 20(2), 1129-1140 (2012).
6. D. Sinefeld and D. M. Marom, “Hybrid guided-wave/free-space optics photonic spectral processor based on LCoS phase only modulator,” IEEE Photon. Technol. Left. 22(7), 510-512 (2010).

Acknowledgement of the above references herein is not to be inferred as meaning that these are in any way relevant to the patentability of the presently disclosed subject matter.

### BACKGROUND

One of the main goals in optical communication techniques concerns maximizing the transmission capacity over fiber-optic systems. To this end, advanced modulation formats, of 16 QAM or even higher modulation orders, have been developed offering high spectral efficiency. However, the use of higher modulation orders suffers from decreased receiver sensitivity, resulting in a higher required optical signal to noise ratio. Another approach for increasing spectral efficiency in wavelength division multiplexed systems, while avoiding loss in receiver sensitivity, is to reduce the channel spacing between the individual WDM channels. Most of the technologies of the kind specified utilize orthogonality between different WDM channels, either in the time-domain (orthogonal frequency division Multiplexing—OFDM), or in the frequency-domain (Nyquist-WDM, denoted N-WDM), capable of placing multiple data signals at the density limit, when the baud rate equals the channel spacing. In coherent optical OFDM (CO-OFDM), phase-locked carriers are synchronously modulated with ideal rectangular pulses in time and sinusoidal frequencies at harmonics of rectangular pulse duration, creating shifted sequences of sinc spectra. The modulation rate equals the carrier separation such that the sinc nulls fall on neighboring carriers. The spectral components of neighboring channels overlap, but each signal component is inter-symbol interference (ISI) free. In N-WDM, the transmitted signal is independently modulated such that the spectral signature of each signal component is square-like. This corresponds to modulating the signal with sinc pulses in time. In N-WDM, the spectral components are completely non-overlapping and the square spectra are packed contiguously, again with the modulation rate equaling the carrier separation. However, each channel has an infinite time response, but ISI is averted by sampling at the sinc peak exactly, due to the constant zero spacing property of the sinc function. CO-OFDM and N-WDM can be seen as complementary schemes, overlapping in either the time or frequency domain. In theory, both modulation formats can reach the same sensitivity performance; however in practical scenarios N-WDM requires less receiver bandwidth (due to its limited spectral extent) and slower analog-to-digital converters [1]. These formats advantageously support the construction of terabit superchannels that propagate between endpoints with no intermediate filtering elements [3].

### GENERAL DESCRIPTION

There is a need in the art for a novel method and system for WDM, in particular Nyquist-WDM, enabling significantly reducing the guard spacing between the channels.

The present invention provides an optical system for use in dense wavelength division multiplexing of data channels with little or no guard bands. The system comprises an optical source unit, and a spectral shaping utility. The optical source unit is configured and operable for producing wavelength-division multiplexed (WDM) modulated data channels having a predetermined spectral arrangement, where each data channel has spectral components owing to modulation format and rate. The spectral components are arranged with certain common m periodicity (defined by spectral width and spectral separation) in K arrays/sets (at least two such arrays/sets) forming a corresponding number of spatially separated broadband optical beams. The spectral components spectral components present data channels, and are arranged in the K sets with certain common periodicity, P, in an interleaved/alternating fashion with spectral components of one array being shifted with respect to the next array a value substantially equal to said periodicity divided by the number of separated broadband beams, i.e. P(K−1)/K. In the simple example, where K=2, the data channels are arranged in first and second arrays with alternating fashion of the spectral components of the two arrays. These two arrays form respectively first and second spatially separated broadband light beams. The spectral components in first and second arrays are shifted one with respect to the other a value substantially equal to a half of the spectral periodicity, P/2, present in said first and second arrays.

The spectral shaping utility is configured and operable for applying spectral shaping to the K arrays to convert modulated-shape of the spectral components in the K arrays to K groups of desired spectral shape of data channels, e.g. rectangular-like shape, sinc shape). Thus, the spectral shaping utility comprises K spectral shapers, e.g. first and second spectral shapers, accommodated in optical paths of the K beams (e.g. first and second light beams), each spectral shaper being configured and operable for shaping (preferably jointly shaping) spectral components of a respective one of the arrays to form a respective group of e.g. rectangular (e.g. square-like) shape spectral channels. The shaping is such that each spectral channel has a spectral width substantially equal to said half of spectral periodicity (or generally P(K−1)/K), and the specifically shaped (rectangular) channels in the groups are arranged with gaps between the channels also of a value substantially equal to e.g. half of said spectral periodicity or, generally, said spectral periodicity minus the spectral width of the channel. Preferably, the spectral width of the channels is also P/K.

The outputs of the K spectral shapers may then be combined. Since the beams being output from the spectral shapers include groups of desirably shaped (e.g. rectangular-shaped, e.g. square-shaped; or sinc shaped) alternating spectral components shifted one with respect to the other as described above, the combined beam includes all the spectral channels spectrally arranged in the interleaved fashion with practically no frequency gap between them, and in case of rectangular-like shaped channels they are practically non-overlapping.

Preferably, each of the spectral shapers is configured for simultaneously applying the above-described shaping to all the spectral components of the respective one of the input arrays. To this end, a photonic spectral processor (PSP) previously developed by the inventors of the present application can be used. Generally speaking, such PSP can operate with a spectral periodicity, denoted free spectral range (FSR) designed to substantially equal said spectral periodicity (e.g. 100 GHz), and imposes the same spectral modulation for all channels spaced at said spectral periodicity. Such PSP is disclosed in [6], which is incorporated herein by reference. The use of such PSPs in the WDM system of the invention provides for optimally reducing the channel spacing while eliminating a need for separate filtering of each channel (conventionally performed by filters per channel [1]).

The WDM of the present invention may thus utilize K such PSPs (e.g. a pair of PSPs) in the optical path of respective K arrays of modulated data channels formed by alternating spectral components arranged with certain periodicity. These are modulated spectral components of input data channels, with channels arranged at certain spectral periodicity. As indicated above, the modulated data channels of K arrays/sets are shifted in frequency one with respect to the other a predetermined value, substantially equal to half-periodicity. The sets of modulated data channels are directed towards respective PSPs, where each PSP operates for simultaneously shaping the plurality of data channels to form a respective plurality of desirably shaped (e.g. rectangular-like shaped) spectral channels (compatible with Nyquist-WDM).

To this end, the PSP includes a dispersive medium, such as an arrayed waveguide grating (AWG), configured for receiving an input data modulated channels and angularly dispersing spectral components of the channels with a finite free spectral range equal to the frequency spacing of the data channels The dispersive medium is followed by optics (lens) including a Fourier lens to modify angular dispersion to spatial dispersion, and a filtering element for selecting attenuation of spectral components, such as spatial light modulator (SLM), located in the Fourier plane of the optics. The periodicity of the AWG (or FSR) matches frequency spacing of data channels, such that the dispersed spectra of all channels is superimposed, thus providing that the multiple spectral channels are modulated in the same manner by the same filtering element. The filtering element is configured for applying attenuation to each spectral component, thereby apodizing a spectrum to a desired shape, i.e. modulating (shaping) the spectral components to square-like shape channels. It should be noted that in such a configuration of PSP, a periodic angular dispersive element may be an etalon with one fully reflective surface, known in the literature as virtual imaged phase array (VIPA).

The optical source unit used in the system of the invention includes or is connected to a data modulated signals generator, which may be of any known suitable configuration, for receiving input light components from CW lasers, applying data modulation to these light component (giving modulated data), and multiplexing them by suitable hardware that further shapes or apodizes the spectrum. For the purposes of the invention, the optical source unit is further configured for spectrally arranging the spectral light components into K arrays with alternating spectral components arranged with certain periodicity and spectral shift between the arrays. To this end, the multiplexers are preprogrammed/controlled to filter the respective data channels between K sets to provide the alternating/interleaved arrangement thereof, as well as provide the required common spectral periodicity and shift of spectral components between the arrays.

According to one broad aspect of the invention, there is thus provided an optical system for use in dense wavelength division multiplexing, the system comprising:

an optical source unit configured and operable for producing K sets of wavelength division multiplexed modulated data channel, forming respectively K spatially separated broadband light beams, wherein each of said K data channel sets is arranged with certain common spectral periodicity P defined by fixed frequency separation between said data channels, said data channels and corresponding spectral components of one of the sets being shifted with respect to data channels and corresponding spectral components of a next set by a value d substantially equal to said periodicity divided by the number K of the arrays, or P(K−1)/K;

K spectral shapers accommodated in optical paths of the K light beams respectively, each of said K spectral shapers being configured and operable for shaping spectral components of a respective one of the K sets of modulated data channel to form a respective one of K groups of desirably shaped spectral channels,

thereby enabling to combine the K light beams into a combined output beam in the form of the interlaced desirably shaped channels of the K groups characterized by substantially zero gap between the channels in said combined output.

According to another broad aspect of the invention, there is provided a method for use in dense wavelength division multiplexing, the method comprising:

(i) producing K spatially separated broadband optical beams comprising respective K arrays of spectral components arranged with certain common periodicity P, where said spectral components present data channels and are arranged in interleaved fashion in the K arrays, with spectral components of one array being shifted with respect to a next array a value substantially equal to half of said periodicity divided by a number of separated broadband beams, or P(K−1)/K;

(ii) applying spectral shaping to said K arrays to convert modulated-shape of the spectral components in the K arrays to K groups of desired spectral shape of data channels; and

(iii) combining the K groups of the spectral channels into a combined beam, said combined beam thereby comprising all the spectral channels being interleaved and characterized by substantially no frequency gap between them.

### BRIEF DESCRIPTION OF THE DRAWINGS

The patent or application file contains at least one drawing executed in color. Copies of this patent or patent application publication with color drawings will be provided by the Office upon request and payment of the necessary fee.

In order to better understand the subject matter that is disclosed herein and to exemplify how it may be carried out in practice, embodiments will now be described, by way of non-limiting example only, with reference to the accompanying drawings, in which:

FIG. 1 shows a block diagram of a wavelength division multiplexer system according to some embodiments of the invention;

FIG. 2 illustrates more specifically an example of the configuration of an optical source unit suitable for use in the system of the invention;

FIG. 3 shows schematically an example of the configuration and operation of the wavelength division multiplexer system of the invention;

FIG. 4 exemplifies the configuration and operation of a photonic spectral processor (PSP) suitable to be used in the wavelength division multiplexer system of the invention;

FIGS. 5A and 5B show experimental results of a square-like spectral filter response of the PSP used in the invention compensating a commercial demux filter: FIG. 5A shows the flattened spectrum for four bandwidths, and FIG. 5B shows the PSP response without the demux; and

FIGS. 6A to 6D show SLM pattern and PSP response for the first and second PSPs of FIG. 3.

### DETAILED DESCRIPTION OF EMBODIMENTS

The present invention provides for a novel WDM system enabling significantly reducing a guard space between the data channels, e.g. providing zero spacing between the channels. To this end, the invention combines high-resolution spectral shaping of K spatially separated light portions formed by K arrays of data modulated signal components respectively with a predetermine arrangement of the spectral components of the K arrays, altering the spectral distribution of the modulated signals into desired shape data channels (e.g. rectangular, or sinc), and then combining the K arrays into an output beam to enter a communication fiber. The arrangement of spectral components is such that the spectral components of the K arrays are arranged in interleaved/alternating fashion with certain common spectral periodicity P and the spectral components of the K arrays are shifted one with respect to one another a value substantially equal to P(K−1)/K.

In the specific but not limiting example, the system is operable with two such arrays of data channels (K=2), and is therefore described below with respect to this example. It should however be understood that the principles of the invention are not limited to this example.

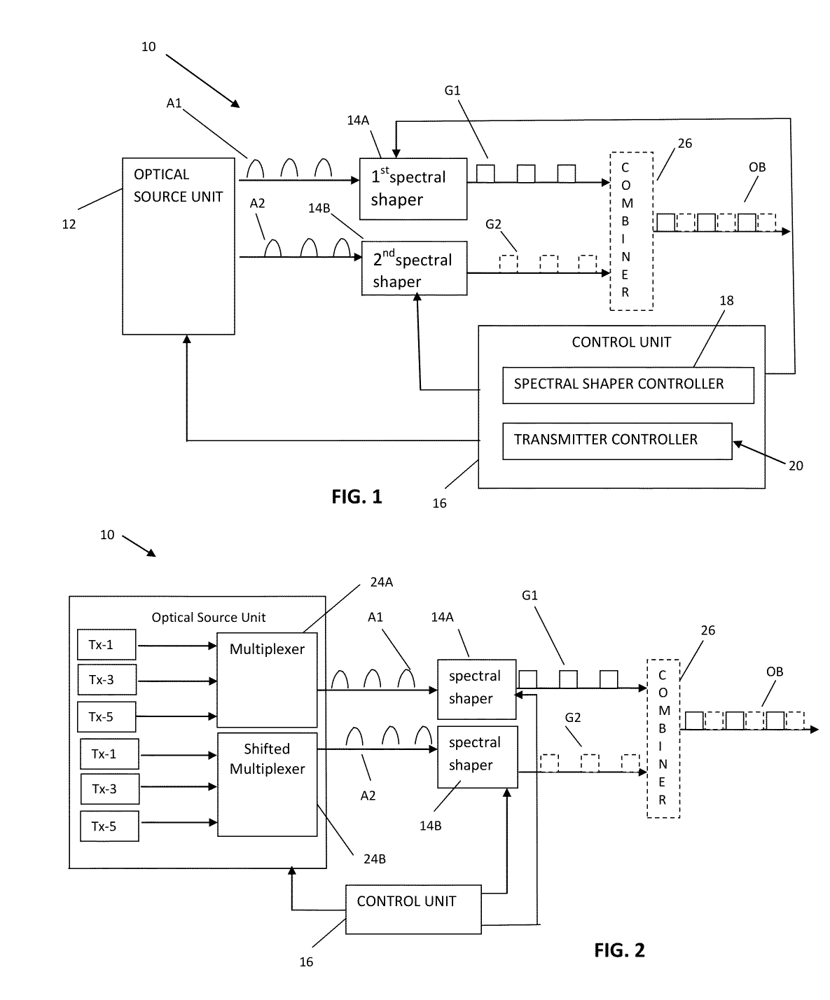

Referring to FIG. 1, there is illustrated by way of a block diagram a WDM system of the invention. The system, generally designated 10, includes an optical source unit 12 which is configured and operable for utilizing (generating or receiving from external generator) multiple modulated data channels each on specific carrier frequencies and providing the above described arrangement of K arrays—two such arrays A1 and A2 being shown in the present not limiting example of spectral components propagating along two spatially separated optical paths; and a corresponding number K (two in the present example) of spectral shaping units 14A and 14B accommodated in the optical paths of the arrays A1 and A2 respectively.

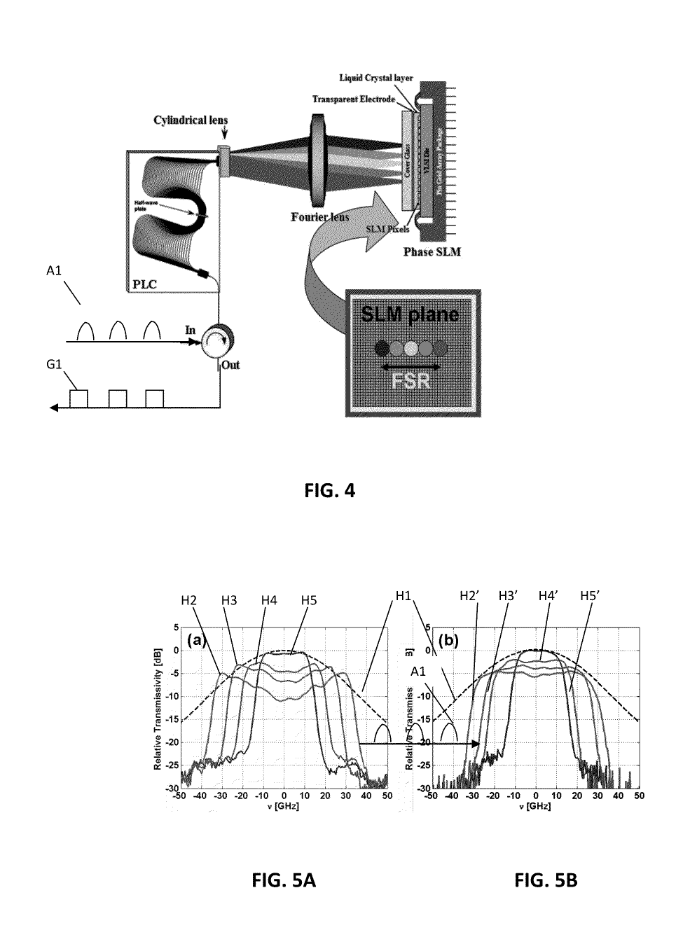

Each of the spectral shaping units is configured for altering the data modulated spectral light components into desired rectangular spectrum. Preferably, the spectral shaping unit is configured as a photonic spectral processor (PSP) developed by the inventors of the present application and disclosed in [6], which is incorporated herein by reference. Such a PSP is configured for simultaneously shaping all the spectral components (channels) in the array, and is capable for imposing the same spectral modulation for all channels arranged with a periodicity denoted free-spectral range (FSR), e.g. 100 GHz. This will be described more specifically further below with reference to FIGS. 4A and 4B.

As shown in FIG. 1, output of the optical source unit 12 is in the form of two arrays of spectral components A1 and A2, where each of the arrays includes a plurality of multiple data modulated optical signals spectrally arranged in a spaced-apart relationship with a certain periodicity, P, preferably equal to the FSR of the spectral shaping units or PSP. The data channels with their corresponding spectral components are arranged in alternating fashion in the arrays A1 and A2. As shown in the simplified example of FIG. 1, array A1 includes data channels λ1, λ3 and λ5 and their corresponding spectral components and array A2 includes data channels λ2, λ4 and λ6 and their spectral components, and data channels in array A2 are spectrally shifted with respect to data channels in array Al a value d of about half-period P, d≈P/2 preferably being substantially equal to FSR/2. It should be understood that generally, for any number K of such arrays/sets of data channels, the shift value between the sets is equal to P(K−1)/K, where K≧2.

The spectral shaper units 14A and 14B may be configured generally similar to one another, being operable with respective predetermined free spectral range (FSR) selected in accordance with the desired spacing between the channels. As shown in the figure, the spectral shapers 14A and 14B process the arrays A1 and A2 and produce groups G1 and G2 of square-like shape spectral channels of a certain spectral width W. Preferably the operational parameters of the spectral shapers are tuned to provide that the spectral width W of the channels equals to FSR/2, with the rectangular-like data spectrum having sharp roll-off edges, and the gaps between successive channels in each group is substantially equal to value d (half of periodicity, or FSR/2 again). This enables to combine the groups G1 and G2 of square-like shape spectral channels into a combined output beam OB in the form of the interlaced square-like shape channels of the first and second groups. In such a combined beam OB the data channels are substantially non-overlapping with substantially zero gaps between the channels.

As indicated above, each spectral shaper is preferably configured so as to simultaneously apply shaping to all the spectral components of corresponding array. This can be implemented utilizing the above-described photonic spectral processor (PSP), the configuration of which will be described in more details further below.

The system 10 may optionally be associated with a control unit 16 (i.e. comprises the control unit as its constructional part or is configured to be connectable to an external control unit via wires or wireless signal transmission). The control unit 16 is typically a computing system including inter alia data input/output utilities, memory, and data processor, which are not specifically shown. For the purposes of the invention, the control unit may be preprogrammed to operate the spectral shapers and/or the optical source unit. To this end, the control unit 16 may include a spectral shaper controller 18 configured to adjust the operational parameter(s) such as filtered width W of the spectral shaper, and/or a transmitter controller 20 configured and operate to adjust the arrangement of the spectral components, i.e. period P, FSR, and a value d of the spectral shift between the two arrays A1 and A2 of spectral components.

Referring to FIG. 2, there is illustrated more specifically an example of the configuration of an optical source unit suitable to be used in the WDM system 10 of the invention. To facilitate understanding, the same reference numbers are used for identifying common functional components in all the examples of the invention. The optical source unit 12 includes or is connected to multiple laser transmitters Tx−1, Tx−2, . . . , Tx−6, each associated with a center wavelength (λ1, λ2, . . . , λ6) and modulated data; and includes multiplexers 24A and 24B. All the odd channels (i.e., Tx−1, Tx−3, and Tx−5) are multiplexed together with multiplexer 24A, generating array A1. All the even channels (i.e., Tx−2, Tx−4, and Tx−6) are multiplexed together with multiplexer 24B generating array A2. Multiplexing combines all the discrete transmitters to one beam, and may introduce some spectral filtering effects. The transmitters being multiplexed together and the corresponding multiplexer are selected to provide the above-described spectrally shifted arrays Al and A2 with the alternating channels.

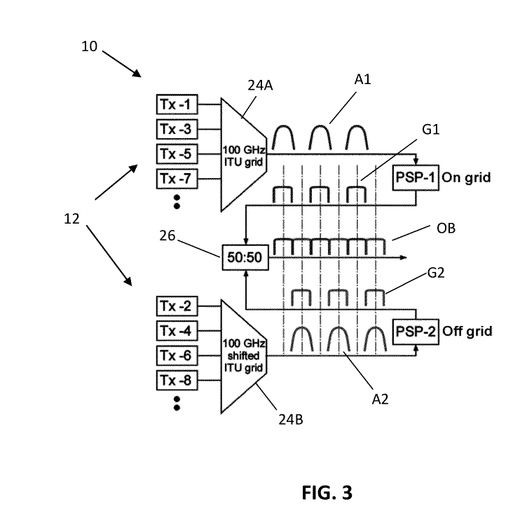

Reference is now made to FIG. 3, showing a specific but not limiting example of the configuration and operation of the WDM system 10 of the present invention. As shown, multiple optical transmitters, Tx−1 to Tx−8, each on a unique laser wavelength residing on the ITU grid and further data modulated are multiplexed together in interleaved fashion forming arrays A1 and A2. Multiplexing combines all the discrete transmitters to one beam, and may introduce some spectral filtering effects. These two signals undergo spectral filtering/multiplexing using for example 100-GHz ITU grid and 100-GHz shifted ITU grid to form two arrays A1 and A2 of interleaved spectral components of certain periodicity with spectral components of one array being shifted with respect to the other a value substantially equal to half-periodicity. Then, the two arrays A1 and A2 pass through/interact with the beams shapers 14A and 14B comprising photonic spectral processors PSP-1 and PSP-2 resulting in the creation of two groups G1 and G2 of square-shaped interleaved spectral components of a spectral width and FSR substantially equal to half-periodicity. These two groups G1 and G2 of the square-shaped spectral components passes through 50:50 beam combiner 26 resulting in the output beam OB in which the spectral components of the two groups are interlaced, corresponding to non-overlapping channels with essentially no gap between them.

Reference is made to FIG. 4 exemplifying a photonic spectral processor PSP suitable to be used as a spectral shaper 14A, 14B in the WDM system of the invention for simultaneously converting multiple data modulated spectral components into square-shaped spectral components spaced at desired FSR. The PSP accepts at its input port multiple data channels spaced at the PSP's FSR, and after the spectral shaping function of the PSP is carried out, the shaped data channels exit at its output port. The PSP includes a dispersive medium, an optical arrangement including a Fourier lens, and a spatial-selective reflecting element serving to select which spectral components are allowed through and which will be attenuated, and the respective attenuation value. The reflecting element may be programmable when implemented with a spatial light modulator (SLM). The dispersive medium may be in the form of an arrayed waveguide grating (AWG) planar light circuit (PLC), e.g. having N grating arms, that are routed to the edge facet are radiate into free-space for unconstrained propagation. The FSR periodicity of the PSP is such that it allows for the simultaneous filtering of all channels spectrally spaced at FSR. Further, the PSP provides for the high resolution filtering, by engineering the AWG optical resolution. The optical resolution of the AWG is approximately equal to the FSR divided by the waveguide arm count, N. An exemplary implementation may have FSR=100 GHz, and N=34 grating arms, resulting in ˜3.5 GHz spectral resolution. In this specific example, the 3.5 GHz optical resolution is sufficient to demonstrate the square-like filtering function.

Thus, the AWG of PSP 14A receives data channels 21, 23, and 25 belonging to array A1, disperses said data channels 21, 23, and 25 in the present example, onto SLM at spectral plane with the Fourier lens. The SLM may modulate any property of light, such that upon coupling back to the AWG will result in attenuation. A particular example may be a liquid crystal on silicon (LCoS) two-dimensional phase SLM that is controlled by a computer. Attenuation may be prescribed by different phase functions applied across the axis orthogonal to the dispersion axis. One example is a linear tilt function that will cause displacement at the AWG and lead to loss. Such a PSP is thus configured as a hybrid guided-wave/free-space optical device. The reflective LCoS SLM is placed at the Fourier plane, where the spectral components of the incident optical signal are dispersed and manipulated. Due to the periodic nature of the dispersion (from the FSR property of the AWG), spectral components that are shifted by FSR multiples overlap in space and the same channel response is achieved every FSR (the colorless property, when the FSR equals the channel separation). Since channels in each array are separable by FSR, this means λ1, λ2, and λ5 will each fall on same positions and experience essentially identical attenuation patterns.

In this example, Holoeye PLUTO LCoS SLM is used which has 1920×1080 pixels of 8 μm pitch, with a system spatial dispersion of dx/dλ=10 [mm/nm], which translate to 100 MHz shift in center frequency. The entire 100 GHz spectrum spans over 1000 columns. For the N-WDM filtering application, the 100 MHz addressability dictates the precision at which the filter bandwidth can be set, and the 3.5 GHz resolution sets the roll-off shape (deviation from ideal square-like filter response).

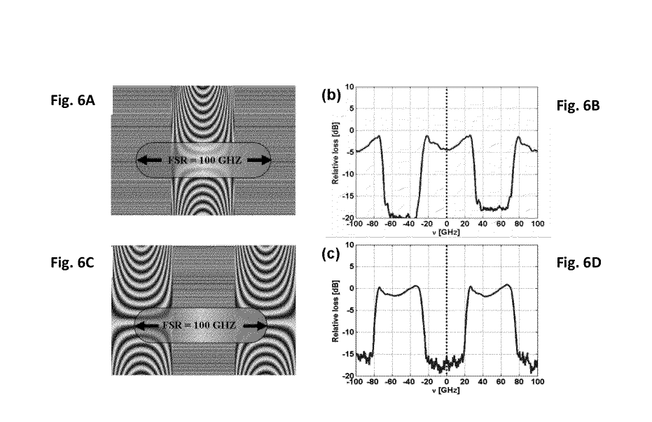

In order to amplitude modulate the dispersed spectral components with a phase-only LCoS SLM, the direction orthogonal to the dispersion is used to locally manipulate the reflected beam. To prescribe amplitude modulation, the SLM phase tilt is modified, on a column by column basis, which introduces a coupling loss back into the AWG for each spectral component, subject to the optical resolution constraint. This is illustrated in FIGS. 6A and 6C showing SLM pattern and PSP filtering response for spectral components at the center of FSR periodicity and offset from center of FSR periodicity, where FIG. 6A shows the SLM pattern for the center of the FSR periodicity channels combined from alternating tilted phase in the central 50 GHz, and constant tilted phase outside, and FIG. 6C shows the SLM pattern for the data channels offset from the center of FSR periodicity combined from alternating tilted phase in the outer 50 GHz, and constant tilted phase in the center.

The required square-like spectral filter response in N-WDM is the cumulative transfer function required, inclusive of multiplexing components. Hence, the response of the multiplexing equipment, typically of Gaussian shape, should also be taken into account. A typical N-WDM implementation would thus separately multiplex the even and odd channels, shape each group to square-like channel response, and passively combine the two halves as exemplified in the above-described FIG. 4. The PSP needs to flatten the response of the multiplexer, by imparting excess loss to the central spectral components, such that they equate to the edge spectral components. For example, one multiplexer can multiplex 50 Gbaud channels spaced at 100 GHz (the second handles the complementary set), each set is then spectrally shaped to a square spectrum of 50 GHz bandwidth, and the two interleaving signal components are then combined. For such scenarios, the colorless property of the PSP is optimal, as each PSP handles multiple channels simultaneously. Furthermore, such colorless PSP is preferably used to reshape both odd channels and even channels (beam shapers 14A and 14B).

FIGS. 5A and 5B show the experimental results demonstrating the generation of a square-like spectral filter response, while compensating a commercial demultiplexing filter (marked with dashed curve H1). FIG. 5A shows spectral PSP response H2-H5 for four target signal bandwidths respectively, designed to compensate and flatter the demultiplexer. As the bandwidth becomes larger, overall PSP attenuation must be increased in order to achieve flattening over the entire bandwidth of interest. FIG. 5B shows the corresponding system response H2′-H5′ comprising the demultiplexer and the PSP. The filter response H1 shown by the dashed curve in FIGS. 5A and 5B is typical to standard WDM demultiplexers. By applying an inverse attenuation function (FIG. 5A) the spectral response of the combined system are flattened. In this way, the square-like spectral response for 20, 30, 50 and 60 GHz bandwidths with <1 dB ripple is obtained (FIG. 5A). As larger bandwidths are prescribed, the overall filter attenuation at center is to be increased in order to achieve equalization.

In order to multiplex together multiple N-WDM channels, a combination of flattened odd channels λ1, λ2, and λ5 and even channels λ2, λ4, and λ6 is needed. The odd channels, falling on the FSR center periodicity, were flattened by applying varying attenuation to form flattened response along the central frequency components of the FSR (the central 50 GHZ), with high attenuation to the remaining spectral components. For the even channels, offset from FSR periodicity, the flattening is performed by shaping the outer frequency components of the FSR using varying attenuation, where the central frequency components are blocked by the high attenuation. The resulting PSP response is shown in FIGS. 6B and 6D. Alternatively, each PSP may incorporate an AWG of the same FSR but frequency shifted from each other by half the FSR, so that each AWG is frequency aligned to the corresponding input data channel group and only the central frequency components of the PSP have to be flattened within each PSP. The attenuation mechanism demonstrated by applying linear phase functions along each vertical column is one of many potential attenuation generating mechanisms. Another alternative may incorporate an amplitude SLM in place of a phase SLM.

Thus, the present invention provides a simple and effective solution for optimally reducing the channel spacing in a WDM system. The present invention provides for creating a beam/signal in the form of the interlaced rectangular-like (e.g. square-like) shape channels arranged in interlaced fashion while the successive channels are substantially non-overlapping and have substantially zero gap between them.

1. An optical system for use in dense wavelength division multiplexing, the system comprising:
an optical source unit configured and operable for producing K sets of wavelength division multiplexed modulated data channels forming respectively K spatially separated broadband light beams, wherein the data channels in said K sets are arranged in alternating fashion with certain common spectral periodicity P defined by fixed frequency separation between said data channels, and the data channels and corresponding spectral components of one of the K sets is shifted with respect to the data channels and corresponding spectral components of a next set by a value d substantially equal to P(K−1)/K;
K spectral shapers accommodated in optical paths of the K light beams respectively, each of said K spectral shapers being configured and operable for shaping spectral components of a respective one of the K modulated data channel sets to form a respective one of K groups of desired shaped spectral channels,
thereby enabling to combine the K spectrally shaped light beams into a combined output beam in the form of the interlaced desirably shaped channels of the K groups characterized by substantially zero gap in said combined output.

2. The system of claim 1, wherein said optical source unit is configured and operable for producing two of such sets of data channels; K=2.

3. The system of claim 1, wherein the desired spectral shape of data channels is substantially rectangular-like of width P/K.

4. The system of claim 3, wherein the interlaced desirably shaped channels of the K groups in the combined output are substantially non-overlapping.

5. The system of claim 1, wherein the desired spectral shape of data channels is sinc function like.

6. The system of claim 1, wherein said optical source unit comprises K multiplexers for receiving multiple optical signals corresponding to multiple data channels, each multiplexer being configured and operable to create a respective one of said K sets of channels with said common periodicity P, wherein said K multiplexers comprise one or more multiplexers configured to apply said spectral shift to the corresponding sets.

7. The system of claim 1, comprising a beam combiner arrangement accommodated in optical paths of said K groups of desired shape spectral channels, to produce a combined output beam in the form of the interlaced desired shape channels of the K groups being substantially non-overlapping and characterized by substantially zero gap between the channels in said combined output.

8. The system of claim 1, wherein each of the K spectral shapers is configured for simultaneously applying said shaping to all the spectral components of the respective one of the K sets.

9. The system of claim 8, wherein each of the K spectral shapers comprises a photonic spectral processor comprising: a dispersive medium having a periodic angular dispersive element, said periodicity equal to twice said frequency separation constituting a free spectral range (FSR), a Fourier lens for converting periodic angular dispersion to periodic spatial dispersion, a spatially-selective reflecting unit for reflecting said periodically spatially dispersed signals back to the lens and dispersive medium with varying attenuation applied to each spectral component and its FSR shifted components, thereby apodizing a spectrum to a desired shape.

10. The system of claim 9, wherein the periodic angular dispersive element comprises an arrayed waveguide grating.

11. The system of claim 9, wherein the periodic angular dispersive element comprises a virtual imaged phase array (VIPA).

12. The system of claim 9, wherein the reflecting unit comprises a spatial light modulator.

13. An optical system for use in dense wavelength division multiplexing, the system comprising:
an optical source unit configured and operable for producing first and second wavelength division multiplexed modulated data channel sets forming respectively first and second spatially separated broadband light beams, the data channel sets being arranged in alternating fashion with certain common spectral periodicity P defined by fixed frequency separation between said data channels, said data channels and corresponding spectral components of the first set being shifted with respect to data channels and corresponding spectral components of the second set by a value d substantially equal to a half of the periodicity, or P/2;
first and second spectral shapers accommodated in optical paths of the first and second light beams, each of said first and second spectral shapers being configured and operable for shaping spectral components of a respective one of the first and second modulated data channel sets to form a respective one of first and second groups of rectangular-like shape spectral channels, wherein each of the channels has a spectral width substantially equal to half of said periodicity, or P/2 and a spectral gap between the channels in each group is also substantially equal to half of said periodicity, or P/2,
thereby enabling to combine the first and second spectrally shaped light beams into a combined output beam in the form of the interlaced rectangular-like shape channels of the first and second groups being substantially non-overlapping and characterized by substantially zero gap in said combined output.

14. A method for use in dense wavelength division multiplexing, the method comprising:
(i) producing K spatially separated broadband optical beams comprising respective K arrays of spectral components arranged with certain common periodicity, P, where said spectral components present data channels and are arranged in interleaved fashion in the K arrays, with spectral components of one array being shifted with respect to the next array a value substantially equal to said periodicity divided by number of separated broadband beams, or P(K−1)/K;
(ii) applying spectral shaping to said K arrays to convert modulated-shape of the spectral components in the K arrays to K groups of desired spectral shape of data channels; and
(iii) combining the K groups of the spectral channels into a combined beam, said combined beam thereby comprising all the spectral channels.

15. The method of claim 14, wherein the number of K spatially separated broadband optical beams is 2.

16. The method of claim 14, wherein the desired spectral shape of data channels is rectangular-like of width P/K.

17. The method of claim 16, wherein the interlaced desirably shaped channels of the K groups in the combined beam are substantially non-overlapping.

18. The method of claim 14, wherein the desired spectral shape of data channels is sinc function like.

19. A method for use in dense wavelength division multiplexing, the method comprising:
(i) producing first and second spatially separated broadband optical beams comprising respective first and second arrays of spectral components arranged with certain common periodicity, where said spectral components present data channels and are arranged in interleaved fashion in the first and second arrays, with spectral components of one array being shifted with respect to the other a value substantially equal to half of said periodicity;
(ii) applying spectral shaping to said first and second arrays to convert modulated-shape of the spectral components in the first and second arrays to first and second groups of rectangular-like shape spectral channels arranged with a channel width and spectral gap between the channels substantially equal to said half periodicity; and
(iii) combining the first and second groups of the spectral channels into a combined beam, said combined beam thereby comprising all the spectral channels being substantially non-overlapping and characterized by substantially zero gap between them.
